(19) United States
(12) Patent Application Publication
(10) Pub. No.: US 2012/0055914 A1
(43) Pub. Date: Mar. 8, 2012

(54) SEAT HEATER AND SEAT WITH SEAT HEATER USING SHEET HEATING ELEMENT

(75) Inventors: Yoshihide Goto, Sagae-shi (JP); Taiki Goto, Sagae-shi (JP); Naoki Akita, Sagae-shi (JP)

(73) Assignee: GOTO DENISH CO.,LTD., Sagae-shi (JP)

(21) Appl. No.: 13/228,431

(22) Filed: Sep. 8, 2011

Related U.S. Application Data
(60) Provisional application No. 61/403,008, filed on Sep. 8, 2010.

(51) Int. Cl. H05B 1/00; H05B 3/20

(52) U.S. Cl. 219/217; 219/520

(57) ABSTRACT

A seat heater includes a base sheet, a plurality of sheet heating elements disposed on the base sheet, and two sheet electrodes coupled to each of the sheet heating elements. Each of the sheet heating elements has a rectangular shape with a long side of not more than 9 cm and a short side of not more than 5 cm. Each of the sheet electrodes is disposed on each of the sheet heating elements substantially along the entire short side of the sheet heating element.

This application claims priority to U.S. Provisional Application Ser. No. 61/403,008, filed on Sep. 8, 2010, entitled “Car seat with heater utilizing planar heating element and hot air generating device at outlet of duct utilizing planar heating element,” which is incorporated herein by reference in its entirety.

### TECHNICAL FIELD

The present invention relates to a seat heater and a seat with a seat heater using a sheet heating element.

### BACKGROUND OF THE INVENTION

Seat heaters employing sheet heating elements are known and heretofore, in recent years, have been configured different ways. These sheet heating element is an element where conductive material made from graphite and carbon black is dispersed over a synthetic resin medium comprised primarily of fluorine-based resins.

For example, Japanese patent application publication No. 2004-55219 proposes a configuration where a number of sheet heating elements are connected via elastic couplings to produce a structure which prevents alterations in the sheet heating elements.

Japanese patent application publication No. 2004-55219 makes it possible to reduce the inherent design limitations of sheet heating elements by connecting multiple sheet heating elements via lead wires, making them a single unit electrically.

Seat heaters employing sheet heating elements are known and heretofore in recent years, have been configured different ways, such as those above. However, these techniques above use pectinate electrodes in their sheet heating elements. Pectinate electrodes have very short distances between electrodes, which requires greater power usage for greater heat generation.

This phenomenon makes seat heaters using sheet heating elements especially unsuitable as automobile seats. This is because the majority of automobiles use a 12 volt (V) direct current (DC) battery as a power source. In addition, hybrid and electric vehicles, which have become more common in recent years, require electricity as a source of mechanical energy. Thus, there is demand to reduce the amount of power being used for seat heaters.

Additionally, from an environmental protection (ecological) standpoint, reducing electricity consumption as much as possible is desirable.

As such, what is needed is to create seat heaters and seats with seat heaters that can efficiently heat to the optimal temperature while conserving electricity.

### SUMMARY OF THE INVENTION

According to one aspect of the present invention, a seat heater of the present invention includes:

a base sheet;

a plurality of sheet heating elements disposed on the base sheet, each of the sheet heating elements having a rectangular shape with a long side of not more than 9 cm and a short side of not more than 5 cm; and

two sheet electrodes coupled to each of the sheet heating elements, wherein each of the sheet electrodes is disposed on each of the sheet heating elements substantially along the entire short side of the sheet heating element.

According to the second aspect of the present invention, a seat with a seat heater of the present invention includes:

a seat having a bottom portion and a back portion, at least one of the bottom portion and the back portion having a plurality of raised portions; and

a seat heater including:
a base sheet;
a plurality of sheet heating elements arranged on the base sheet, each of the sheet heating elements having a rectangular shape with a long side of not more than 9 cm and a short side of not more than 5 cm; and
sheet electrodes arranged on the sheet heating element substantially along the two entire short sides of the sheet heating element,

wherein the seat heater is provided at least one of the bottom portion and the back portion along the raised shape of the raised portion, and wherein the sheet heating elements are arranged in the vicinity of tops of the raised portions.

According to the third aspect of the present invention, a seat heater of the present invention includes:

a base seat;

a belt-like sheet heating element disposed on the base seat; and

a plurality of sheet electrodes disposed on the sheet heating element at regular intervals, the sheet electrodes substantially ranging over an entire width of the sheet heating element,

wherein the sheet heating element is folded multiple times.

The seat heater and the seat with the seat heater using sheet heating element of the present invention use multiple, relatively small, sheet heating elements and structure their electrodes to effectively utilize the whole sheet heating elements. Thus, it is possible to further increase energy efficiency while maintaining the optimal temperature.

### BRIEF DESCRIPTION OF DRAWINGS

FIG. 1 is a rough block diagram of a seat with a seat heater in accordance with the first embodiment.

FIG. 2 is a diagram of the structure of a seat heater in accordance with the first embodiment.

FIG. 3 is a partial cross-sectional diagram of the A-A line of the seat heater in accordance with the first embodiment.

FIG. 4A shows a comparison example 1 relating to the seat heater in accordance with the first embodiment.

FIG. 4B shows a comparison example 2 relating to the seat heater in accordance with the first embodiment.

FIG. 4C shows a comparison example 3 relating to the seat heater in accordance with the first embodiment.

FIG. 4D shows a comparison example 4 relating to the seat heater in accordance with the first embodiment.

FIG. 5 is a diagram displaying the operation of a seat heater in accordance with the first embodiment.

FIG. 6 is a rough block diagram of a seat with a seat heater in accordance with the second embodiment.

FIG. 7 is a diagram of the structure of a seat heater in accordance with the second embodiment.

FIG. 8 is a diagram of the structure of a seat heater in accordance with the second embodiment.

FIG. 9A is a photograph of the parallel-stitched lines used in a seat heater in accordance with the second embodiment.

FIG. 9B is a cross-sectional diagram of the parallel-stitched lines used in a seat heater in accordance with the second embodiment.

FIG. 10A is a diagram of the structure of a hot air generator in accordance with the third embodiment.

FIG. 10B is a diagram of the structure of a hot air generator in accordance with the third embodiment.

FIG. 10C is a diagram of the structure of a hot air generator in accordance with the third embodiment.

FIG. 10D is a diagram of the structure of a hot air generator in accordance with the third embodiment.

FIG. 11A is a frontal view diagram of a variant structure example of the hot air generator in accordance with the third embodiment.

FIG. 11B is a right side view diagram of a variant structure example of the hot air generator used in the third embodiment.

FIG. 12 is a diagram of the structure of a foot heater in accordance with the fourth embodiment.

### DETAILED DESCRIPTION OF THE INVENTION

Embodiments of the present invention will be described hereinafter with reference to the accompanying drawings, in which the preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing the preferred exemplary embodiments of the disclosure. It should be noted that this invention may be embodied in different forms without departing from the spirit and scope of the invention as set forth in the appended claims.

### First Embodiment

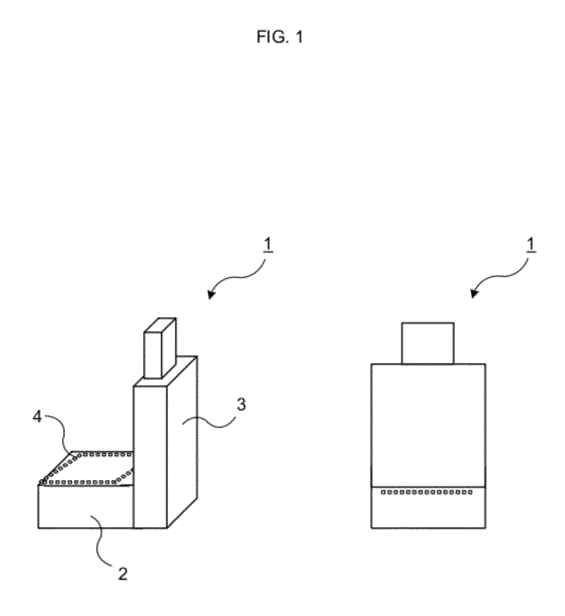

FIGS. 1 through 5 will be used to explain a seat heater and a seat with a seat heater in accordance with the first embodiment.

FIG. 1 is a rough block diagram of the seat with the seat heater 1 in accordance with the first embodiment. The seat with the seat heater 1 includes the bottom portion 2 and the back portion 3. In this embodiment, the seat heater 4 is installed in the bottom portion 2. More particularly, the seat heater 4 is located on the underside of a seat cover on the surface of the bottom portion 2. Thus, the seat heater 4 is invisible through the surface of the bottom portion 2. The seat with the seat heater of this embodiment is for use in automobiles.

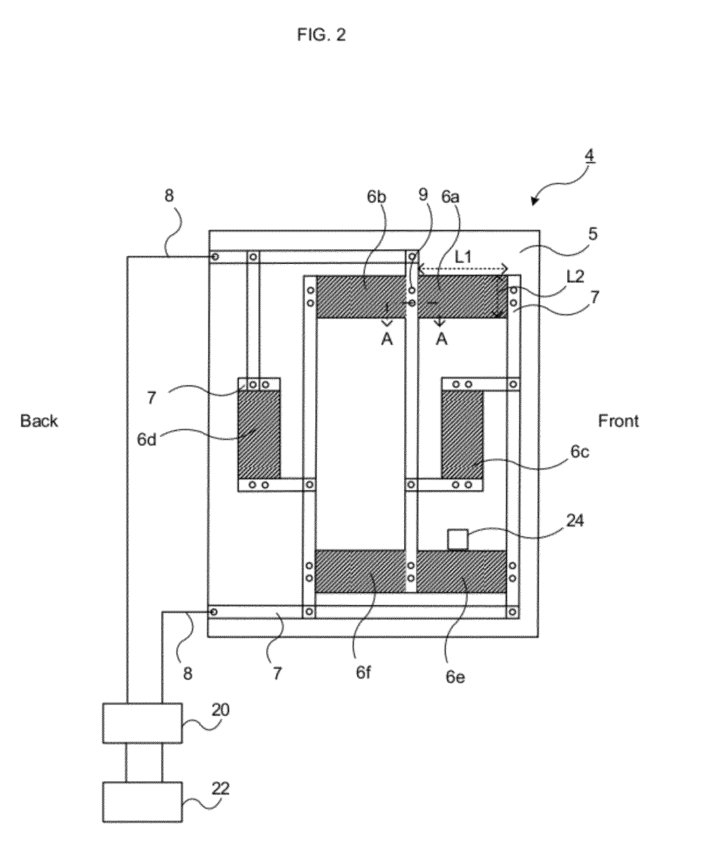

FIG. 2 is a plan view of the structure of the seat heater 4. The seat heater 4 includes a base sheet 5, a plurality of sheet heating elements 6a-6f located on top of the base sheet 5, and the sheet electrodes 7 which link the sheet heating elements 6a-6f (unless specifying a particular sheet heating element from the group, the term, “sheet heating elements 6,” will be used). The sheet electrodes 7 are stretched to the edge of the base sheet 5, where they are connected to a wiring 8. The wiring 8 connects to a controller 20. The controller 20 connects to a power source 22. A temperature sensor 24 is adjoined to the sheet heating element 6 and connected by a wire (not shown in the figures) to the controller 20. To the right side of the figure is the front side of the bottom portion 2, namely, the direction the user's legs would be located. Contrarily, the left side of the figure is the rear side of the bottom portion 2, namely, the direction the user's back would be located.

Preferably, the base sheet 5 is made from a thin material and retains its flexibility. An example of such a material would be a non-woven fabric (PET). The non-woven fabric has a porous structure, making it air permeable and heat retaining, which makes it ideal for seat heaters. They are most especially suited for seat heaters used in car seats where the user must sit in the same place for a long period of time.

Each of a plurality of the sheet heating elements 6 is an element where conductive material made from graphite and carbon black is dispersed over a synthetic resin medium comprised primarily of fluorine-based resins. The sheet heating element is extremely thin, and highly flexible.

Also, each sheet heating element has a rectangular (oblong) shape. Preferably, each sheet heating element 6 has a long side length L1 of not more than 9 cm and a short side length L2 of not less than 5 cm. The reason for this will be described below in relation to the sheet electrodes 7. Thus, by using numerous, comparatively small sheet heating elements, it is possible to heat only the necessary parts of the surface of the seat with little energy waste. In other words, the sheet heating elements do not need to be placed in areas that are not necessary to heat, which leads to electric power saving. In this embodiment, each sheet heating element is 7 cm in the long side length L1, and 3.3 cm in the short side width L2.

In this embodiment, the total area of all the sheet heating elements is 138.6 cm². In a normal automobile, the size of the seat is generally at least 38 cm in width and 40 cm in depth. In terms of area, that is 1,520 cm². As such, in this embodiment, the sheet heating elements cover only about 9.1% of the total area of the bottom portion 2, which is not more than 10% Thus, it is apparent that this embodiment, by only heating the necessary areas, succeeds in conserving electricity.

In this embodiment, the sheet heating elements 6a and 6b are adjoined at their short sides. Similarly, the sheet heating elements 6e and 6f are also adjoined at their short sides. As such, there are two sets of the sheet heating elements 6 that are adjoined at their short sides. Both sets of the sheet heating elements, 6a and 6b, as well as 6e and 6f, have their long sides aligned in an anteroposteriorly (front-back) direction of the bottom portion 2. This direction matches the direction of the user's thighs. Also, their location puts them in contact with the user's thighs. In this way, the oblong sheet heating elements 6 (6a and 6b as well as 6e and 6f) are set in the areas that need heating the most, making them more effective.

Furthermore, sheet heating element 6d is located in the rear of the bottom portion 2, and sheet heating element 6c is located in the front of the bottom portion 2. The long sides of both sheets are aligned left-to-right across the bottom portion 2. The sheet heating element 6d is located where the user's hip would be located. The sheet heating element 6c is complementarily located between where the user's legs would be located. In this way, the six sheet heating elements 6 are located in such a way to heat only the parts that need heating, thus making it possible to heat efficiently.

A plurality of sheet electrodes 7 are located in alignment with the two short sides of the sheet heating element 6. This structure where the sheet electrodes are only located along the short sides of the sheet heating element 6 makes it possible to lower electricity consumption. This reduction is due to the relatively wide distance (7 cm) between the sheet electrodes, which allows for that much less electricity to be consumed. Especially in cases where pectinate electrodes are spread over almost the entire surface of the sheet heating element, as the distance between electrodes is small, it results in higher electricity consumption. When compared with this configuration, the present embodiment can achieve less power consumption. For the sheet electrodes 7, the use of copper foil is preferable. Further, the sheet electrode 7 is swaged and fixed to the sheet heating element 6 with a rivet 9.

As stated above, in terms of electricity conservation (lower power consumption), more distance between the sheet electrodes 7 is better. This is because as resistance increases, electrical current decreases. From this point of view, based on the experiments of the inventors, it is preferable that the distance between the sheet electrodes 7 be 6 cm or greater. However, in terms of heating, if the distance between the sheet electrodes 7 is too great, then adequate heating cannot be achieved. Especially with low voltage power sources such as DC 12V automobile batteries, achieving adequate heating can be impossible. From this point of view, based on the experiments of the inventors, it is preferable that the distance between the sheet electrodes 7 be 9 cm or less. As such, the optimal distance between the sheet electrodes (i.e. the long side length L1 of the sheet heating element 6) is not less than 6 cm and not more than 9 cm.

In this embodiment, the sheet electrodes 7 are arranged along substantially the entire short sides of the sheet heating element 6. The reason for this arrangement is that by doing so, the entirety of each sheet heating element 6 is able to produce heat. Especially in this embodiment, which uses comparatively small sheet heating elements, it is desirable to be able to use the limited heating element effectively.

Furthermore, as stated above, it is preferable that the short side of the sheet heating element 6 be 5 cm or less. If the short side is greater than 5 cm and the sheet electrodes are arranged along the entirety of the short side, the amount of electricity consumed will increase, thus making it unfavorable. Of course, if the sheet electrodes 7 are only arranged along a part of the short side, it will not cause the amount of electricity consumed to increase. However this arrangement will cause part of the sheet heating element 6 to go unused, which means the entire heating element cannot be used effectively.

Also, the optimal length for the sheet electrodes 7 on the sheet heating element 6, namely the length of the short side of the sheet heating element 6 is 3 cm or greater. If it is less than 3 cm, it is impossible to achieve adequate heating.

As such, the optimal length for the short side of the sheet heating element 6 is not less than 3 cm and not more than 5 cm.

Furthermore, a single sheet electrode 7 is in contact with the short sides of both sheet heating elements 6a and 6b. In this case, it is preferable that the sheet heating elements 6a and 6b be seamlessly connected into a single entity. By connecting them into a single entity, adequate contact area for the sheet electrodes 7 can be secured, and the risk of damage due to the weight of the user is mitigated. This also applies to the sheet heating elements 6e and 6f similarly.

Also, adjoining the sheet heating element 6 is the temperature sensor 24. The temperature sensor 24 measures the temperature of the sheet heating element 6. Incidentally, the temperature sensor 24 can also be placed such that it measures the temperature of the space between the sheet heating elements 6, rather than the temperature of the sheet heating elements 6 themselves.

In addition, a plurality of the sheet electrodes 7 electrically connect the sheet heating elements each other. The sheet electrodes 7 are electrically connected to the wiring 8. The wiring 8 is connected to the controller 20.

The controller 20 has a switch by which the user can turn the power to the seat heater 4 on or off, as well as buttons to set the temperature of the seat heater 4. The controller 20 can also be electrically connected to the temperature sensor 24 for the seat heater 4, the automobile's ignition switch (not pictured), as well as the seat belt sensor (not pictured), etc. If the controller 20 is connected to these other parts, the temperature of the seat heater, the on-off of the automobile's ignition, and the buckled or unbuckled states of the seatbelt, etc., will function together, making it possible to further control the seat heater 4. In addition, it is preferable that in automobiles where multiple seats are equipped with seat heaters 4, each seat heater 4 has its own controller 20. With this structure, each seat can control the operation of its own seat heater 4.

The controller 20 is connected to the power source 22. In this embodiment, the power source 22 is the automobile's battery.

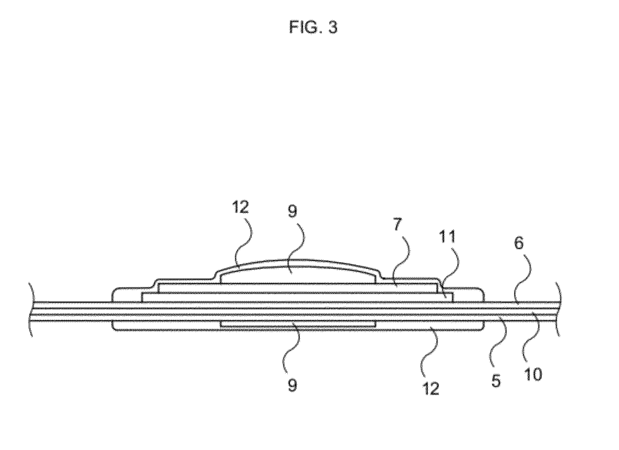

FIG. 3 is a partial cross-sectional diagram of the seat heater 4. More particularly, FIG. 3 is a partial enlarged cross-sectional diagram of the A-A line in FIG. 2.

According to FIG. 3, the sheet heating elements 6 are attached to the top of the base sheet 5 via double-sided tape 10. Also, the sheet electrodes 7 are attached to the top of the sheet heating element 6 with silver solder 11. The silver solder 11 is applied to a part of the top of the sheet heating elements 6 in advance during the manufacturing process. It is also possible to apply adhesive to the sheet electrodes 7, as well. This is because if the sheet electrodes 7 are joined to the sheet heating element with silver solder 11 alone, because silver solder's adhesive force is not strong enough, an adequate bond cannot be formed. Thus, it is optimal to use the sheet electrodes 7 to which adhesive has been applied. In addition, the sheet electrodes 7 are ultimately secured by rivets 9.

These rivets 9 swages the sheet electrodes 7, the silver solder 11, the sheet heating element 6, the double-sided tape 10, and the base sheet 5 together. Additionally, a kapton seal 12 covers the rivets 9, the sheet electrodes 7 and the silver solder 11. The kapton seal 12 electrically insulates the sheet electrodes 7. In this way, the sheet electrodes 7 are strongly fastened to the sheet heating element 6 with the rivets 9. In a case where the electrodes are pectinate and arranged across the entirety of the sheet heating element, there are multiple points of contact on one sheet heating element. Thus, there is no need for concern over the contact between each electrode and the sheet heating element. However, in a case of this embodiment where the points of contact between the sheet heating element 6 and the sheet electrodes 7 are limited, adequate precautions against contact failure must be taken. This is why, as written above, this embodiment is structured with both the rivets 9 and the silver solder 11 to fasten, and plentiful surface area is reserved for electrical contact.

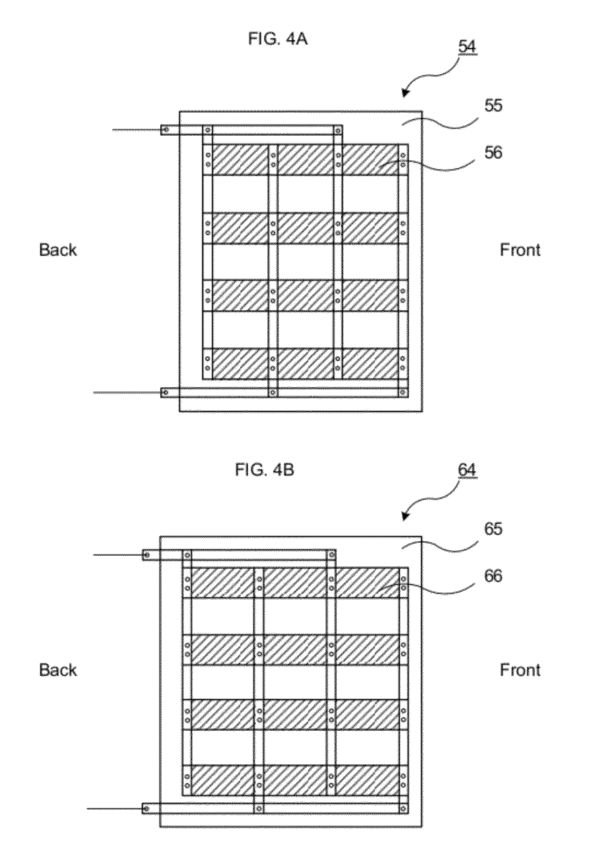

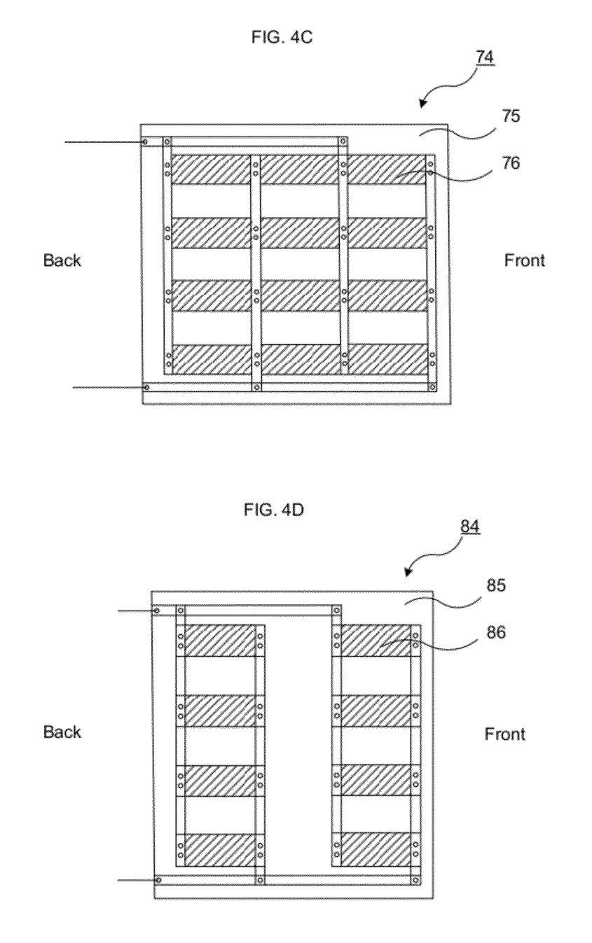

FIGS. 4A through 4D explain the results of experiments using seat heaters that are structurally different from the seat heater 4 of this embodiment. The experimental results for the seat heater 4 of this embodiment will also be explained.

### Comparative Example 1

FIG. 4A is a diagram of the structure of a seat heater 54 according to comparative example 1. As shown in the figure, twelve sheet heating elements 56 are spread across the entire face of the base sheet 55. Each sheet heating element has a length of 6 cm in the long side and 3.3 cm in the short side. The power source is DC 12V supplied from an automobile cigarette lighter. Each sheet heating element takes an electric current of 133 mA, for a total of 1,596 mA across all twelve. The measured temperature on the surface was 48° C., which is very hot and not a comfortable sitting temperature for long periods of time.

### Comparative Example 2

FIG. 4B is a diagram of the structure of a seat heater 64 according to comparative example 2. As shown in the figure, twelve sheet heating elements 66 are spread across the entire face of the base sheet 65 similar to comparative example 1. Each sheet heating element has a length of 7 cm in the long side and 3.3 cm in the short side. The power source is DC 12V supplied from an automobile cigarette lighter. Each sheet heating element takes an electric current of 103.4 mA, for a total of 1,240.8 mA across all twelve sheets. The measured temperature on the surface was 45° C., which is also quite hot and not a comfortable sitting temperature for long periods of time.

### Comparative Example 3

FIG. 4C is a diagram of the structure of a seat heater 74 according to comparative example 3. As shown in the figure, twelve sheet heating elements 76 are spread across the base sheet 75. Each sheet heating element has a length of 9 cm in the long side and 3.3 cm in the short side. The power source is DC 12V supplied from an automobile cigarette lighter. Each sheet heating element takes an electrical current of 69.5 mA, for a total of 834 mA across all twelve sheets. The measured temperature on the surface was 42° C., which is still a somewhat high and uncomfortable temperature.

### Comparative Example 4

FIG. 4D is a diagram of the structure of a seat heater 84 according to comparative example 4. As shown in the figure, eight sheet heating elements 86 are arranged along only the front and rear portions of the base sheet 85. Each sheet heating element has a length of 7 cm in the long side and 3.3 cm in the short side. The power source is DC 12V supplied from an automobile cigarette lighter. Each sheet heating element takes 103.4 mA of electric current, for a total of 827.2 mA across all eight. The measured temperature on the surface was 40° C., which is still a somewhat high and uncomfortable temperature.

Subsequently, according to the structure of the seat heater 4 of this embodiment that is shown in FIG. 2, six sheet heating elements 6 are arranged as explained above and also as shown in FIG. 2. Each sheet heating element has a length of 7 cm in the long side and 3.3 cm in the short side. The power source is DC 12V supplied from an automobile cigarette lighter. Each sheet heating element takes an electric current of 103.4 mA, for a total of 620.4 mA across all six sheets. The current value of each of the sheet heating elements is not more than 110 mA, which is very low. The recorded temperature on the surface was between 37° C. and 40° C., a comfortably usable temperature. Additionally, each participant in a 10-person usage trial rated it to be a moderate temperature.

Thus, the seat heater 4 of this embodiment used only 0.62 A of electric current, proving its low electricity consumption, while supplying what is a comfortable temperature to the user.

### (Operation)

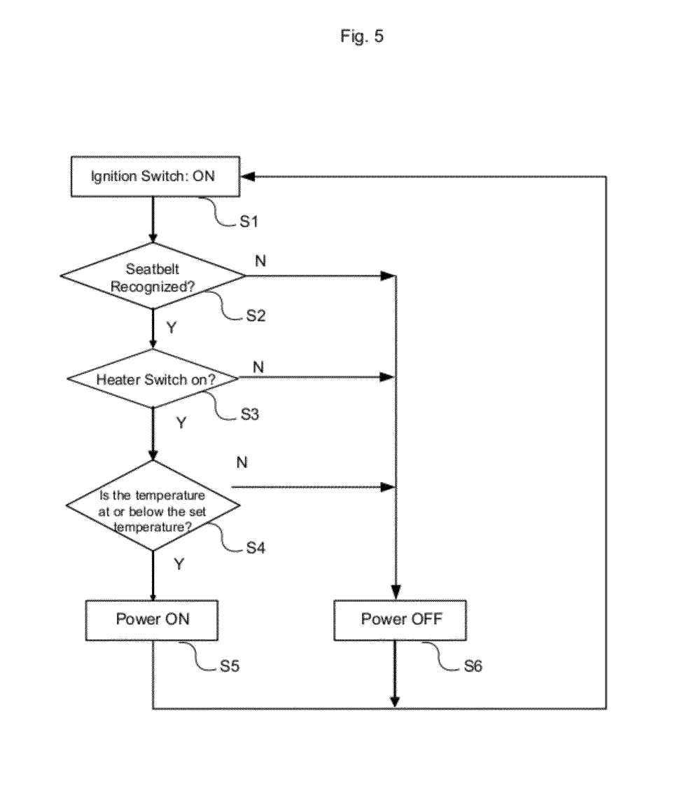

Next, FIG. 5 shows an example of the operation of the seat heater 4 according to this embodiment. This is an explanation of the operation of a seat heater 4 installed in an automobile. More particularly, it is an operation example where the on-off power switch of the seat heater 4 is linked to the ignition switch, seatbelt, etc. The operation is executed by the controller 20 in FIG. 2. In order to operate in this way, the controller 20 must be connected to the temperature sensor 24, the ignition switch, and the seat belt sensor. Operating in this manner makes it possible for the seat heater 4 to begin heating automatically, which is not only convenient, but also increases safety.

First, in step S1, the user turns on the ignition switch of the car.

Next, in step S2, it is determined whether or not the seat belt is buckled in. More particularly, the seat belt sensor connected to the controller 20 detects whether or not the seat belt has been buckled in. If the seatbelt is buckled in, the operation proceeds to step S3. If the seat belt is not buckled in, the operation proceeds to step S6.

In step S3, the controller 20 detects whether or not the equipped, user-controlled heater switch has been switched on or not. If the heater is on, the operation proceeds to step S4, if the heater is off, the operation proceeds to step S6. For example, it is possible to set the heater switch in the on position in advance, in which case the operation will automatically continue to step S4.

In step S4, it is determined whether or not the temperature of the heater is at or below the set temperature. More particularly, the temperature of the heater is determined based on the temperature measured by the temperature sensor 24. If the temperature of the heater is at or below the set temperature, the operation proceeds to step S5. If the temperature of the heater is above the set temperature, the operation proceeds to step S6.

In step S5, the power of the seat heater 4 is turned on. On the other hand, in step S6, the power of the seat heater 4 is turned off. This sequence of operations is repeated.

Therefore, according to the above operation, if the user leaves the power switch of the seat heater 4 in the on position, when the user gets into the car, turns on the ignition and buckles in his/her seatbelt, the seat heater 4 will automatically turn on. Thus, using the seat heater is made more convenient. On the other hand, even if the power switch of the seat heater 4 is left on, as long as the user is not in the vehicle, the seat heater 4 will not turn on, thus lowering the risk of fires and other accidents and improving safety. Also, as long as the ignition switch is not turned on, the seat heater 4 will not turn on, thus preventing the battery from being drained. For example, if the user forgets to turn off the power switch of the seat heater 4 and gets off the vehicle, the battery may continue to supply power while the vehicle is left alone, thereby causing the battery to be drained. However, the above operation can prevent this kind of accident.

In addition, in an automobile where multiple seats are equipped with seat heaters 4 and each seat heater has its own controller 20, only seats where someone is sitting will have their seat heaters 4 turned on automatically. More particularly, first, the switches of all the seat heaters 4 of all the seats are set to the on position. From this state, if the user turns on the ignition, and the user and the passengers buckle their seat belts, only those seats whose seat belts have been buckled will have their seat heaters 4 turn on, while those seats where no one is sitting will not have their seat heaters 4 turn on. As such, even if the user changes nothing, only those seats with the seat heaters 4 in which a person is sitting will heat up, and those seats with seat heater 4 in which no person is sitting will not heat up. Thus, it is possible to provide an efficient, electricity-conserving seat heater 4. However, in order to perform this operation, the vehicle must have seat belt sensors equipped on every seat.

The above operation is only one example, and any step may be removed. For example, it is possible to remove step S2 in a case where the seat heater 4 does not have to be linked with the seat belt sensor. In another example, it is possible to remove step S4 for the seat heater 4 which does not have temperature sensors 24.

As explained above, the seat heater and the seat with the seat heater of the first embodiment conserve electricity by using the minimum sheet heating element and widening the space between electrodes, while providing the user with a comfortable level of warmth. The seat heater and the seat with the seat heater are especially suited for use in automobiles.

### Second Embodiment

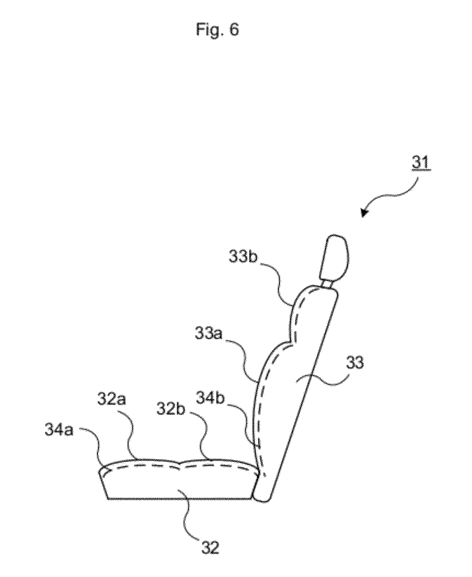

FIGS. 6 through 9 will be used to explain a seat heater and a seat with a seat heater in accordance with the second embodiment. The second embodiment offers a seat heater suited for vehicle seats with two raised portions on both their bottom portion and back portion respectively. Also, by using a belt-like sheet heating element, this embodiment offers seat heaters with exceptional production efficiency.

FIG. 6 is a rough block diagram of the seat with the seat heater 31 in accordance with the second embodiment. The seat with the seat heater 31 includes the bottom portion 32 and the back portion 33. In this embodiment, each of the bottom portion 32 and the back portion 33 has two raised portions. Namely, the bottom portion 32 has raised portions 32a and 32b, and the back portion 33 has raised portions 33a and 33b. Also, seat heater 34a is installed in the bottom portion 32, while seat heater 34b is installed in the back portion 33. Seat heaters 34a and 34b are both located under the seat covers of the bottom portion 32 and the back portion 34, respectively. Thus, the seat heaters 34a and 34b are invisible through the surface of the bottom portion 32 and back portion 33. In addition, the seat heaters 34a and 34b are installed along the shape of the raised portions 32a, 32b, 33a, and 33b. The seat with the seat heater 31 of this embodiment is for use in automobiles.

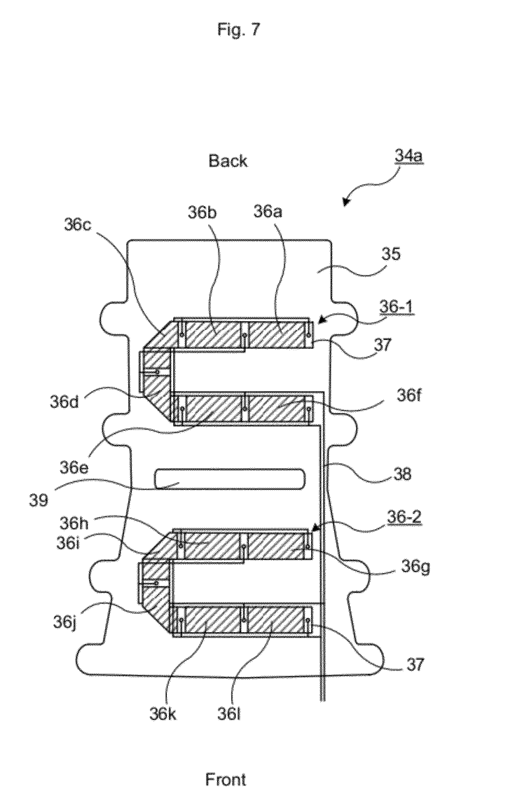

FIG. 7 is a top view diagram of the seat heater 34a for the bottom portion. The seat heater 34a is comprised of the base sheet 35 and a plurality of sheet heating elements 36a-361 located on top of the base sheet 35 (incidentally, unless specifying a particular sheet heating element from the group, the term, “sheet heating elements 36,” will be used). A plurality of the sheet heating elements 36 are divided into a first sheet heating element group 36-1 and a second sheet heating element group 36-2. There is a gap 39 between the two groups of sheet heating elements in the base sheet 35. Also, on top of the sheet heating element 36, there are multiple sheet electrodes 37 installed at predetermined intervals. The multiple sheet electrodes 37 are connected to each other by the wiring 38. The wiring 38 connects each sheet electrode 37 and extends outside the base sheet 35. The wiring 38 is electrically connected to a power source (not shown). The lower direction of the figure is the front side of the bottom portion 32, namely, the direction the user's legs would be facing. Contrarily, the upper direction of the figure is the rear (back) side of the bottom portion 32, namely, the direction the user's back would be facing. In addition, this embodiment can also include the controller 20 and the temperature sensor 24 similar to the first embodiment.

The base sheet 35 is made from the same materials as the base sheet 5 of the first embodiment. In the second embodiment, the base sheet 35 conforms to the uneven shape of the seat with the seat heater 31. More particularly, the base sheet 35 is roughly rectangular and around the middle lengthwise, there is a long, thin gap 39. This gap 39 is located at the concave portion between the two raised portions 32a and 32b on the bottom portion 32. A locking member fixes the gap 39 onto the concave portion. This makes it possible to keep the base sheet 35 shaped to fit the contours of the raised portions 32a and 32b.

A plurality of the sheet heating elements 36a through 361 are made from the same materials as the sheet heating element 6 of the first embodiment. Also, each sheet heating element 36 has the same shape and size as each sheet heating element 6 of the first embodiment. It is especially preferable that the sheet heating element 36 has a long side of not more than 9 cm and a short side of not more than 5 cm. In this way, similar to the first embodiment, by using multiple, small sheet heating elements, only the necessary areas of the seat above are heated with little energy waste. In other words, sheet heating elements do not need to be placed in areas that are not necessary to heat, thus conserving electricity.

In this embodiment, the total area of the sheet heating elements 36 is 255.42 cm² (7×3.3×12−(3.3×3.3÷2×4)=255.42. The subtracted portion represents the folded portion of the sheets.). In a normal automobile, the seats are generally 38 cm in width and 40 cm in depth. In terms of area, that is 1,520 cm². As such, in this embodiment, the sheet heating elements cover only about 16.8%, which is not more than 20%, of the total area. Thus it is apparent that this embodiment, by only heating the necessary areas, succeeds in conserving electricity.

In this embodiment, the sheet heating elements 36a through 36f included in the first sheet heating element group 36-1 are of a belt-like shape. More particularly, the sheet heating elements 36a through 36f are formed into a single, continuous entity (body). The sheet heating elements 36g through 361 included in the second sheet heating element group are likewise of a belt-like shape. The belt-like sheet heating elements 36 are folded twice. This arranges the first sheet heating element group 36-1 and the second sheet heating element group 36-2 into U-shaped arrangements.

These U-shaped arrangements of sheet heating element groups are installed near the tops of the raised portions 32a and 32b on the bottom portion 32 of the seat with the seat heater 31, however, the sheet heating elements are not installed at the concave portion between the raised portions 32a and 32b. The user's body does not come in contact with the non-raised portions of the seat, thus the sheet heating elements only heat the areas with which the user's body comes in contact, which is much more efficient.

The multiple sheet electrodes 37 are installed along the short sides of each pair of sheet heating element 36. More particularly, all the sheet heating elements are in contact with and share the sheet electrodes 37 with the adjoining sheet heating elements 36. Adjoining sheet heating elements are arranged into a single entity, which reserves adequate contact surface area for the sheet electrode 37 while mitigating the risk of damage due to the weight of the user. The space between the sheet electrodes 37 and the lengths of the sheet electrodes are the same as the sheet electrodes 7 of the first embodiment. More particularly, for the reasons explained in the first embodiment, the optimal distance between the sheet electrodes 37 (i.e. the length of the sheet heating element 36), is not less than 6 cm and not more than 9 cm, while the optimal length of the sheet electrodes 37 (i.e. the length of the short side of the sheet heating element 36) is not less than 3 cm and not more than 5 cm.

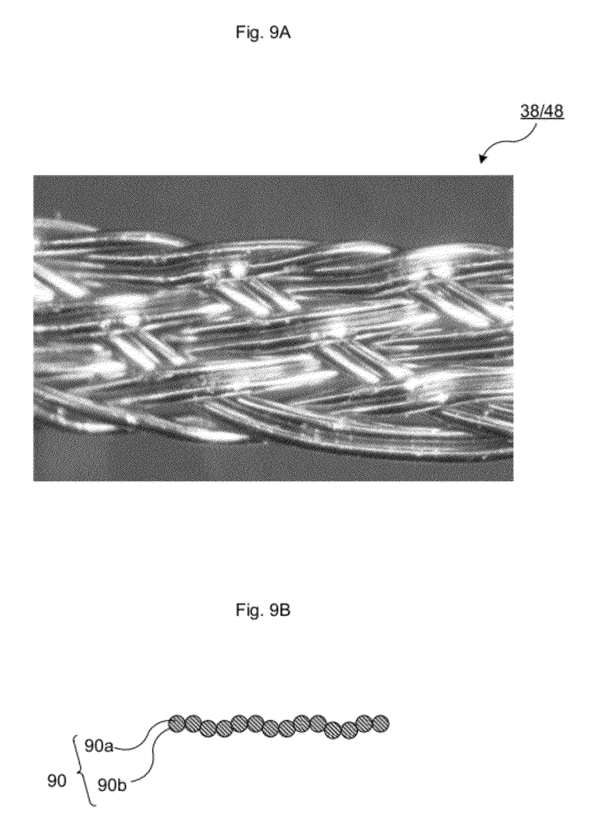

In this embodiment, the wiring 38 electrically connects the multiple sheet electrodes 37 to each other. Also in this embodiment, the wiring 38 uses parallel weaved wire. Parallel weaved wire, as shown in FIGS. 9A and 9B, is a type of wiring with multiple conductive wires weaved together to form a flat shape. More particularly, as shown in FIG. 9B, the wire 90 is composed of the conductor 90a and an insulating film 90b which covers the conductor 90a. Two wires 90 form one set. Seven of these sets are woven together into a flat shape.

When compared to a lead wire or a copper foil, the parallel weaved wire has the following merits. First, because the lead wires are thick, when the user sits down, the lead wires can be recognized by the user, which reduces the comfort of the seat for the user. Also, lead wires have poor elasticity. Next, the copper foil is thin, thus the user will not recognize it. However, when the user sits down on the copper foil, the copper foil makes noise (a rustling sound), which can make the user feel uncomfortable. In addition, it has poor elasticity and is expensive. The parallel weaved wire is much thinner than lead wires, so the user will not recognize or feel them through the seat. Also, it does not make noise like the copper foil and has superb elasticity. Parallel weaved wire is also less expensive than the copper foil. Thus, the parallel weaved wire is the most appropriate material for use as the wiring 38.

In addition to connecting the sheet electrodes 37 to each other, the wiring 38 extends outside of the base sheet 35 and is connected to the controller and the power source (e.g. an automobile battery) similar to the first embodiment. It is also possible to install the temperature sensor adjoining the sheet heating element 36. These structures are the same as those explained in the first embodiment, so additional diagrams have been omitted.

As above, on top of the continuous belt-like arrangement of the sheet heating element 36, the sheet electrodes 37 are installed at the same intervals. This arrangement has a merit during the production process of the seat heater 34a. More particularly, during the production process, first the sheet electrodes 37 are installed on the belt-like sheet heating element 36 at the same intervals. Then the sheet heating element is cut into groups by a set number (e.g. six) of the sheet heating elements. These cut groups of the sheet heating elements are then connected to the wiring 38. After that, the sheet heating element group is folded, and attached to the top of the base sheet 35. This production process is simple compared to cases where pieces of the sheet heating elements must be made before being placed in their set pattern.

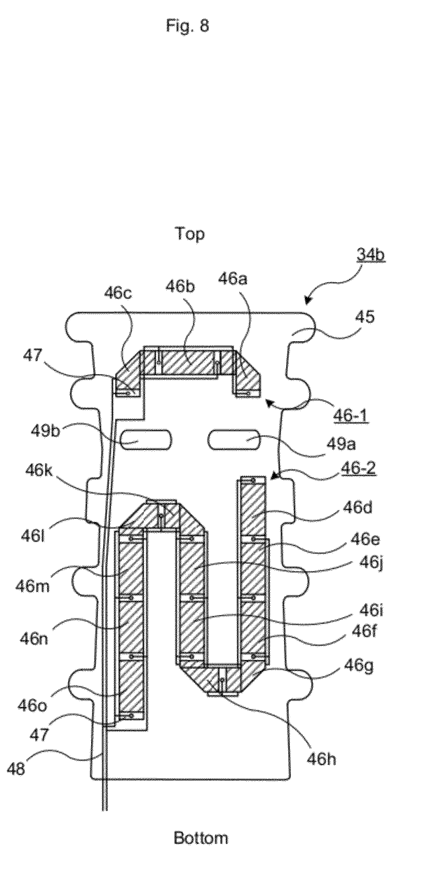

FIG. 8 is a top view diagram of the seat heater 34b for the back portion. The seat heater 34b is comprised of the base sheet 45 and a plurality of sheet heating elements 46a-46o located on top of the base sheet 45 (incidentally, unless specifying a particular sheet heating element from the group, the term, “sheet heating elements 46,” will be used). A plurality of the sheet heating elements 46 are divided into the first sheet heating element group 46-1, and the second sheet heating element group 46-2. There are two gaps 49a and 49b in the base sheet 45 between the two groups of sheet heating elements. Also, on top of the sheet heating element 46, there are multiple sheet electrodes 47 installed at predetermined intervals. The multiple sheet electrodes 47 are connected to each other by the wiring 48. The wiring 48 connects to each sheet electrode 47 and extends outside the base sheet 45. The wiring 48 is electrically connected to a power source (not shown). The lower direction of the figure is the lower direction of the back portion 33, namely, the position of the user's hips and lower back. Contrarily, the upper direction of the figure is the upper direction of the back portion 33, namely, the position of the user's head. In addition, this embodiment can also include the controller 20 and the temperature sensor 24 similar to the first embodiment.

The base sheet 45 is made from the same materials as the base sheet 5 of the first embodiment. In the second embodiment, the base sheet 45 conforms to the uneven shape of the seat with the seat heater 31. More particularly, the base sheet 45 is roughly rectangular and there are two long, thin gaps 49a and 49b located at the upper part lengthwise. These gaps 49a and 49b are located at the concave portion between the two raised portions 33a and 33b on the back portion 33. A locking member fixes the gaps 49a and 49b onto the concave portion. This makes it possible to keep the base sheet 45 shaped to fit the contours of the raised portions 33a and 33b.

A plurality of the sheet heating elements 46a through 46o are made from the same materials as the sheet heating element 6 of the first embodiment. Also, each sheet heating element 36 has the same shape and size as each sheet heating element 6 of the first embodiment.

In this embodiment, the sheet heating elements 46a through 46c included in the first sheet heating element group 46-1 are of a belt-like shape. More particularly, the sheet heating elements 46a through 46c are formed into a single, continuous entity. The sheet heating elements 46g through 46o included in the second sheet heating element group are likewise of a belt-like shape. The belt-like sheet heating elements 46 are folded twice. This arranges the first sheet heating element group 46-1 into a U-shaped arrangement, as shown in the figure, and the second sheet heating element group 46-2 into an S-shaped arrangement, as shown in the figure.

These U-shaped and S-shaped arrangements of the sheet heating element groups are installed near the tops of the raised portions 33a and 33b on the back portion 33 of the seat with the seat heater 31, however the sheet heating elements are not installed at the concave portion between the raised portions 33a and 33b. The user's body does not come in contact with the non-raised portions of the back portion, thus the sheet heating elements only heat the areas with which the user's body comes in contact, which is much more efficient.

The configuration of the sheet electrodes 47 and the wiring 48 are the same as those described in FIG. 7 with reference to the seat heater 34a for the bottom portion, and are omitted here.

As mentioned above, on the continuous belt-like sheet heating element 46, the sheet electrodes are installed at set intervals in the seat heater 34b for the back portion as well. This arrangement shows its merit during the production process of the seat heater 34b. More particularly, during the production process, first the sheet electrodes 47 are installed at the same intervals on the belt-like sheet heating element 46. Then the sheet heating element is cut into groups by set numbers (e.g. twelve and three). These cut groups of the sheet heating elements are then connected to the wiring 48. After that, the sheet heating element group is folded, and attached to the top of the base sheet 45. This production process is simple compared to cases where pieces of the sheet heating elements must be made individually before being placed in their set pattern.

In this way, according to the second embodiment, in addition to improving the efficiency of manufacturing seat heaters, the seat heater and the seat with the seat heater that efficiently heats those parts of the user's body in contact with the seat is offered. This seat heater and the seat with the seat heater are especially suited for use in automobiles.

### Third Embodiment

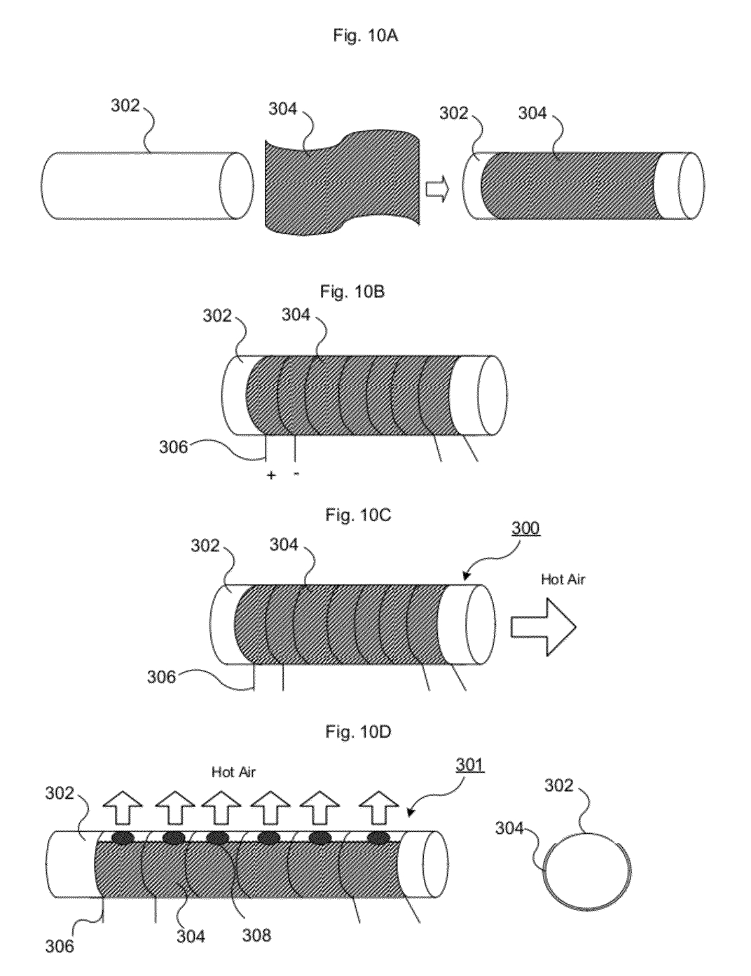

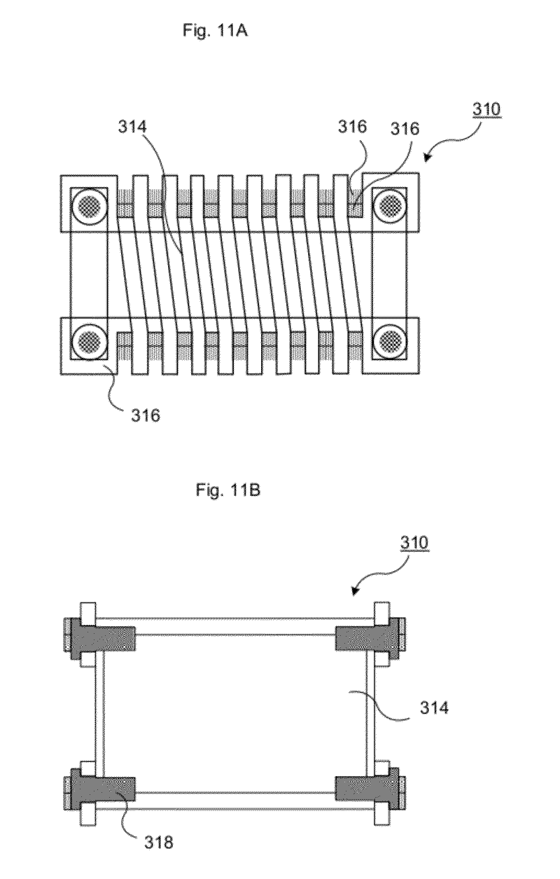

A hot air generator utilizing a sheet heating material of the third embodiment of this invention are explained with FIGS. 10A and 10B along with its manufacturing process.

In FIG. 10A, an aluminum pipe 302 is insulated, and a pipe 302 is wrapped in a sheet heating element 304.

In FIG. 10B, two naked wires 306 are prepared and wrapped around the sheet heating element 304 at a fixed distance from each other. The closer the two naked wires 306 are to one another, the higher the temperature rises. Once the naked wires 306 have been wrapped around the sheet heating element 304, an insulating sheet (e.g. Sumitube®, etc.) is wrapped over the naked wires. These naked wires apply voltage to the sheet heating element 304 and cause it to generate heat.

In this way, the completed hot air generator 300, as shown in FIG. 10C, heats the air, which is passed through the pipe and expels it as hot air. The hot air generator 300 can be installed in the air ducts (outlets) of a vehicle.

Also, as shown in FIG. 10D, the sheet heating element 304 are wrapped around the pipe 302 in such a way as to leave exposed the top of the pipe 302, in which several holes have been drilled, and one end of the pipe 302 is covered. (The diagram on the right of the figure is a cross section.) In this way, the hot air generator 301 draws in air from the uncovered end, and expels hot air through the holes 308. The hot air generator 301 can be used in the windshield air ducts as a defroster, deicer, and is also effective in heating the upper portion of the interior of the automobile. In this case, it is better to direct the hot air towards the user's eye-level in the windshield, rather than the lower half of the windshield. It is common in contemporary automobiles (gasoline-fueled) to direct hot air at the lower portion of the windshield, however, when considered from the vantage of electricity conservation, it is more efficient to target the eye-level portion of the windshield, which is the most necessary area to defrost or device.

### (Variant Structure Example)

FIGS. 11A and 11B will be used to explain an example of a variant structure of the hot air generator using the sheet heating element according to the third embodiment. FIG. 11A is a frontal view diagram, while 11B is a right side view diagram.

In FIG. 11A, the sheet heating element 314 are installed in a continuous fashion with 20 mm of space between them. A total of 17 sheets are installed. The external housing is a copper plate 316. FIG. 11B shows the screws 318.

In this example of a hot air generator 310, when a DC 12V power source was applied and hot air was generated, the hot air generator took a current of 4.59 A and produced hot air at 115° C. (room temperature is 24° C.). Thus, as a hot air generator, it was able to produce adequately high temperatures.

### Fourth Embodiment

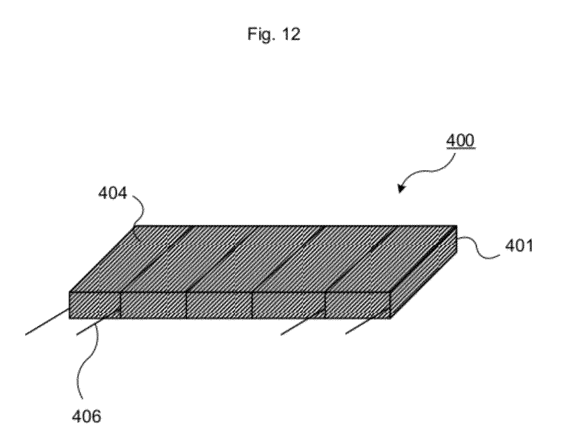

FIG. 12 will be used to explain the foot heater using the sheet heating element according to the fourth embodiment of this invention.

FIG. 12 is a rough diagram of the structure of a foot heater 400 in accordance with the fourth embodiment. In the foot heater 400, the sheet heating element 404 are wrapped around the board component 401. More particularly, the sheet heating element 404 are wrapped over the top face as well as the surrounding four side surfaces of the board component 401. Two naked wires 406 are wrapped around the sheet heating element 404 at set intervals. Furthermore, it is preferable if the board component 401 is made of a heat-storing material, so that even after the power source has been turned off, the board component 401 retains heat.

This type of foot heater 400 is suited for installation in the floors of automobiles in the position where the user's feet would be placed. In this way, the user's feet can be heated locally.

What is claimed is:

1. A seat heater comprising:
a base sheet;
a plurality of sheet heating elements disposed on the base sheet, each of the sheet heating elements having a rectangular shape with a long side of not more than 9 cm and a short side of not more than 5 cm; and
two sheet electrodes coupled to each of the sheet heating elements,
wherein each of the sheet electrodes is disposed on each of the sheet heating elements substantially along the entire short side of the sheet heating element.

2. The seat heater as recited in claim 1, wherein the sheet electrodes of the sheet heating elements are connected each other by parallel weaved wires where multiple conductive wires are weaved together to form a flat shape.

3. The seat heater as recited in claim 1, wherein each of the sheet heating elements has the long side of not less than 6 cm and the short side of not less than 3 cm.

4. The seat heater as recited in claim 1, further comprising a silver solder formed between the sheet heating element and the sheet electrode,
wherein the sheet heating element, the silver solder and the sheet electrode are fixed with a rivet.

5. The seat heater as recited in claim 1, wherein the sheet heating elements being adjacent at the short side each other are formed as s single body.

6. The seat heater as recited in claim 1, wherein a total area of all the sheet heating elements is not more than 20% of an area of a bottom portion of a seat where the seat heater is installed.

7. The seat heater as recited in claim 1, wherein a current value of each of the sheet heating elements is not more than 110 mA.

8. The seat heater as recited in claim 1, wherein the sheet electrode is made of a copper foil.

9. A seat with a seat heater comprising:
a seat having a bottom portion and a back portion, at least one of the bottom portion and the back portion having a plurality of raised portions; and
a seat heater including:
a base sheet;
a plurality of sheet heating elements arranged on the base sheet, each of the sheet heating elements having a rectangular shape with a long side of not more than 9 cm and a short side of not more than 5 cm; and
sheet electrodes arranged on the sheet heating element substantially along the two entire short sides of the sheet heating element,
wherein the seat heater is provided at least one of the bottom portion and the back portion along the raised shape of the raised portion, and
wherein the sheet heating elements are arranged in the vicinity of tops of the raised portions.

10. The seat with the seat heater as recited in claim 9, wherein the sheet electrodes of the sheet heating elements are connected each other by parallel weaved wires where multiple conductive wires are weaved together to form a flat shape.

11. The seat with the seat heater as recited in claim 9, wherein each of the sheet heating elements has the long side of not less than 6 cm and the short side of not less than 3 cm.

12. The seat with the seat heater as recited in claim 9, wherein the seat heater provided at the bottom portion includes a set of a plurality of the sheet heating elements being adjacent at the short side each other, and the long sides of at least two of the sheet heating elements are aligned in a left-to-right direction of the seat.

13. The seat with the seat heater as recited in claim 12, wherein the set of the sheet heating elements includes a U-shaped portion.

14. The seat with the seat heater as recited in claim 12, wherein the sheet heater provided at the bottom portion includes two sets of a plurality of the sheet heating elements being adjacent at the short side each other.

15. The seat with the seat heater as recited in claim 9, wherein the seat heater provided at the back portion includes a set of a plurality of the sheet heating elements being adjacent at the short side each other, and the long sides of at least two of the sheet heating elements are aligned in an up-down direction of the back portion.

16. The seat with the seat heater as recited in claim 15, wherein the set of the sheet heating elements includes a U-shaped portion.

17. The seat with the seat heater as recited in claim 9, wherein a total area of all the sheet heating elements is not more than 20% of an area of the bottom portion of the seat where the seat heater is installed.

18. A seat heater comprising:
a base seat;
a belt-like sheet heating element disposed on the base seat; and
a plurality of sheet electrodes disposed on the sheet heating element at regular intervals, the sheet electrodes substantially ranging over an entire width of the sheet heating element,
wherein the sheet heating element is folded multiple times.

19. The seat heater as recited in claim 18, wherein an each part of the sheet heating elements which is divided by the sheet elements has the long side of not less than 6 cm and not more than 9 cm and the short side of not less than 3 cm and not more than 5 cm.

20. The seat heater as recited in claim 18, wherein an each part of the sheet heating elements which is divided by the sheet elements has a current value of not more than 110 mA.
